(19) United States
(12) Patent Application Publication
(10) Pub. No.: US 2010/0296863 A1
(43) Pub. Date: Nov. 25, 2010

(54) TRANSMISSION MECHANISM FOR TONER CARTRIDGE

(75) Inventors: Chao Chan Yang, Changhua County (TW); Chih-Chi Hsu, Changhua County (TW); Chao-Feng Yang, Changhua County (TW)

Correspondence Address: RABIN & Berdo, PC, 1101 14TH STREET, NW, SUITE 500, WASHINGTON, DC, 20005, US

(73) Assignee: Long Wing Scientific Enterprise Co., Ltd., Taipei County (TW)

(21) Appl. No.: 12/470,686

(22) Filed: May 22, 2009

(51) Int. Cl. F16D 1/10

(52) U.S. Cl. 403/359.6

(57) ABSTRACT

A transmission mechanism for a toner cartridge for use in a printing apparatus includes a transmission tenon provided with a plurality of radial ribs each having a first chamfer, and a transmission sleeve internally provided with a plurality of radial grooves. Each of the grooves includes a second chamfer at the opening end of the transmission sleeve. The number of the grooves is twice the number of the ribs, which provides more positions allowing the transmission tenon to engage with the transmission sleeve. Thus, the ribs can engage with the grooves more quickly and accurately, whereas the coupling of the chamfers can reduce contact interference and allows smoother movement transmission. The occurrence of malfunctions can be thereby reduced.

### BACKGROUND OF THE INVENTION

1. Field of the Invention

The present invention generally relates to a transmission mechanism for a toner cartridge, and more particularly to a transmission mechanism for a toner cartridge for use in a printing apparatus, such as a printer, a copy machine, a xerographic device, etc.

2. The Prior Arts

FIG. 1 is a schematic view showing a conventional transmission mechanism 3 which connect a toner cartridge with a printing apparatus, such as a printer, a copy machine, a xerographic device, etc. As shown, the conventional transmission mechanism 3 is provided at one side of a cartridge body 20 to drive components disposed in the cartridge body 20. The transmission mechanism 3 includes a transmission tenon 31 and a transmission tenon 32. The transmission tenon 32 is coupled with a printing roller and a set of gears (not shown) in the cartridge body 20. The transmission tenon 32 includes a coupling end 321 that is exposed outside of the cartridge body 20 and has a triangular cross section. During operation, the transmission tenon 32 externally connects with the transmission sleeve 31. The transmission sleeve 31 has a coupling groove 311 corresponding to and engaged with the coupling end 321. Through a transmission gear in the printing apparatus, the transmission sleeve 31 and the transmission tenon 32, the printing apparatus can drive the printing roller and the gears in the cartridge body 20, thereby operating the printing work.

When the toner cartridge is going to be mounted in the printing apparatus, the triangular coupling end 321 has to be aligned with the coupling groove 311 to properly engage the transmission tenon 32 with the transmission sleeve 31. If the triangular coupling end 321 is not aligned with the coupling groove 311, it needs to rotate the triangular coupling end 321 to be aligned with the coupling groove 311. However, when the triangular coupling end 321 is rotated, the triangular coupling end 321 of the transmission tenon 32 is pressed against the transmission sleeve 31, which results in wears. Moreover, the cross section of the triangular coupling end 321 is relatively large, which results in more wears. As the transmission mechanism is usually made of plastics, cracks may easily occur therein when it is subjected to higher frictional contact. In addition, because the shape of the coupling end 321 is triangle, the maximum angle, which the coupling end 321 needs to rotate to be aligned with the coupling sleeve 311, is 120 degrees. As a result, before the coupling end 321 is rotated to an engaging position, substantial frictional wears may occur during rotation, which increases the occurrence of damages in use.

### SUMMARY OF THE INVENTION

A primary objective of the present invention is to provide a transmission mechanism for a toner cartridge for use in a printing apparatus, such as a printer, a copy machine, a xerographic device, which allows quick coupling, accurate engagement and reducing malfunction occurrences.

The solution of the present invention is to provide a transmission mechanism for a toner cartridge that includes a transmission tenon and a transmission sleeve. The transmission tenon and the transmission sleeve are coupled with a driving member of a printing apparatus and a driving axle in the toner cartridge, respectively. The transmission tenon has a plurality of evenly distributed ribs that protrude radially and extend longitudinally parallel to an axis of the transmission tenon. Each of the ribs includes a first chamfer at a front end thereof. The transmission sleeve has a plurality of evenly distributed grooves corresponding to the ribs. An outer edge of the groove is provided with a second chamfer that facilitates the insertion and engagement of the rib in the groove. The number of the grooves is equal to a multiple of the number of the ribs, which provides more positions allowing the transmission tenon to engage with the transmission sleeve.

Because the number of the grooves is equal to a multiple of the number of the ribs, there are more positions allowing the transmission tenon to engage with the transmission sleeve. Thus, the transmission tenon only needs to rotate a small angle to engage with the transmission sleeve, which reduces friction wears therebetween. Moreover, the first chamfers and the second chamfers make it easier to engage the transmission tenon with the transmission sleeve.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a perspective view showing a conventional transmission mechanism for a toner cartridge;

FIG. 2 is a perspective view illustrating a use configuration of a transmission mechanism for a toner cartridge according to a first embodiment of the present invention;

FIG. 3A is a side view showing a transmission sleeve of the transmission mechanism according to the first embodiment of the present invention;

FIG. 3B is a side view showing a transmission tenon of the transmission mechanism according to the first embodiment coupled with a gear;

FIG. 4 is a partially cut-away view showing the transmission mechanism according to the first embodiment of the present invention;

FIG. 5 is a perspective view showing an assembly of the transmission mechanism according to the first embodiment of the present invention;

FIG. 6 is a perspective view showing a use configuration of a transmission mechanism for a toner cartridge according to a second embodiment of the present invention;

FIG. 7A is a side view showing a transmission sleeve of a transmission mechanism according to a third embodiment of the present invention engaged with a gear; and

FIG. 7B is a side view showing a transmission tenon of the transmission mechanism according to the third embodiment of the present invention.

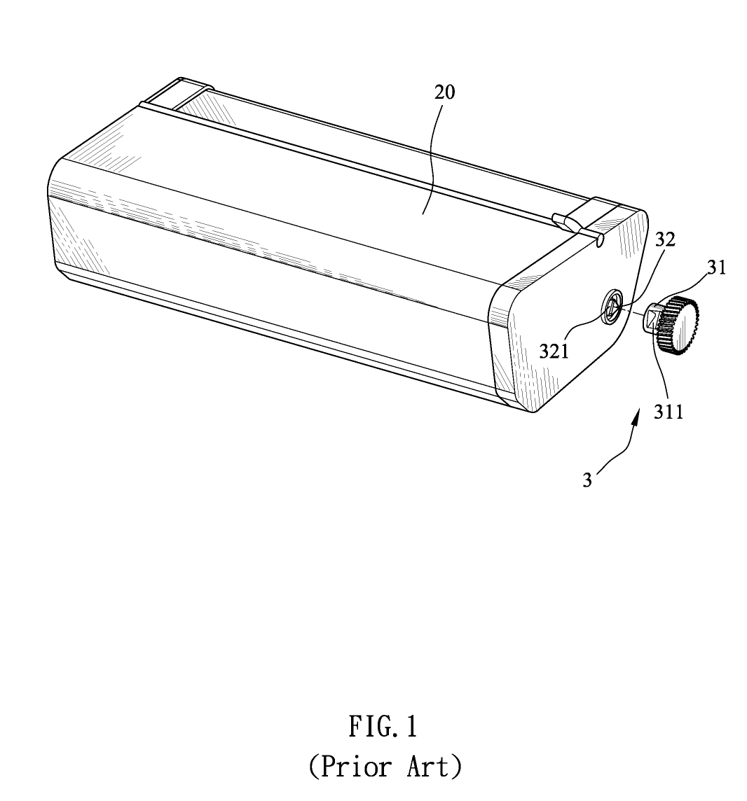

### DETAILED DESCRIPTION OF THE PREFERRED EMBODIMENTS

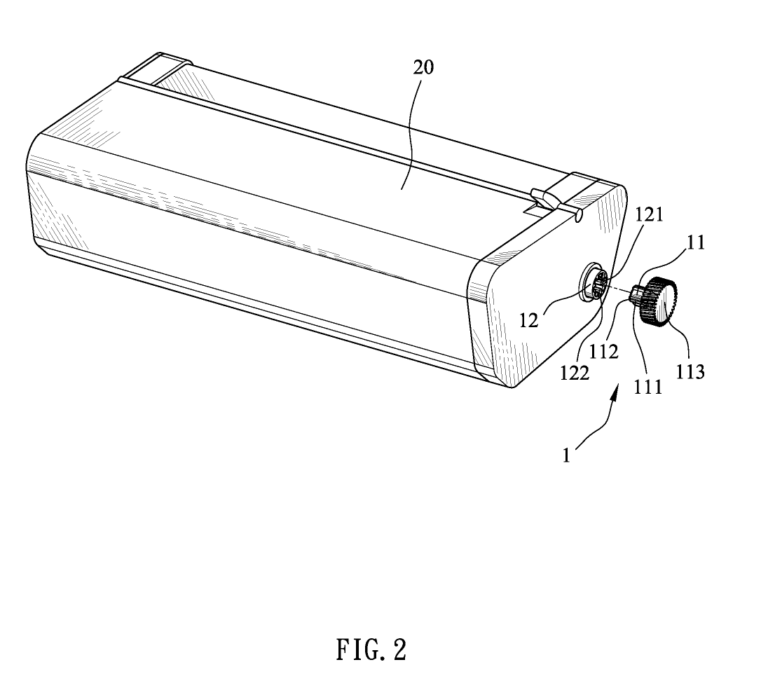

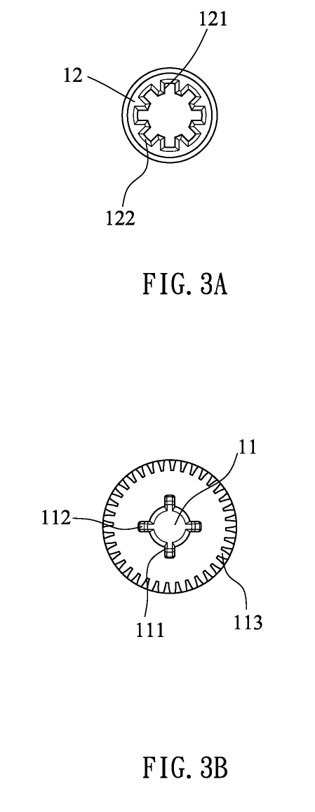

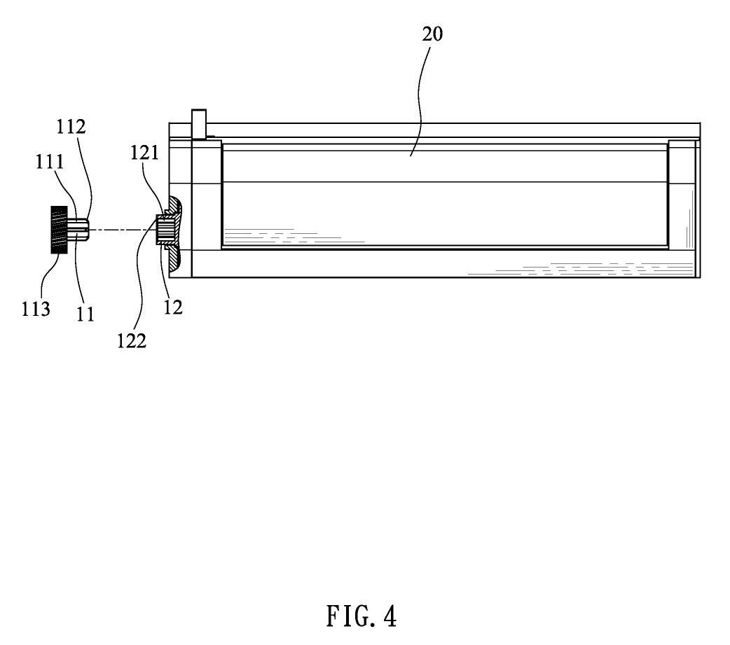

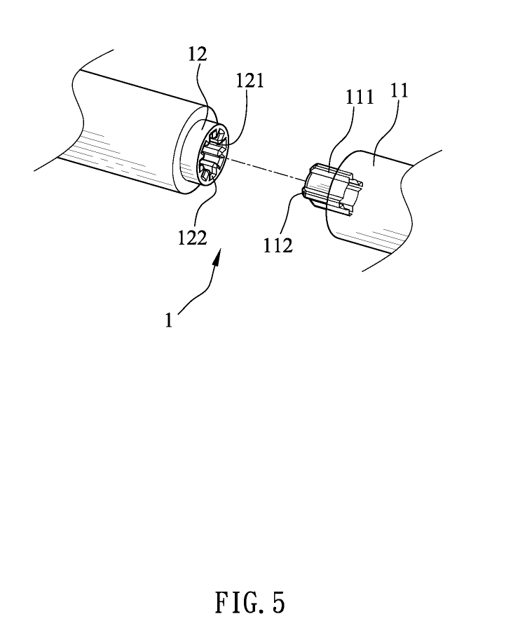

FIGS. 2, 3A, 3B, 4 and 5 show a transmission mechanism 1 for a toner cartridge for use in a printing apparatus according to a first embodiment of the present invention. The printing apparatus includes a printer, a copy machine, a xerographic device, etc. The transmission mechanism 1 includes a transmission tenon 11 and a transmission sleeve 12 engaged with the transmission tenon 11. The transmission tenon 11 and the transmission sleeve 12 are coupled with a driving member of the printing apparatus and a driving axle (not shown in figures) in a cartridge body 20, respectively. The transmission tenon 11 is an axle shaft that includes a plurality of ribs 111 that protrude radially and extend longitudinally parallel to an axis of the transmission tenon 11. The ribs 111 are evenly distributed. The transmission tenon 11 according to the first embodiment has four ribs 111. However, a different numbers of ribs 111 may also be provided. A front end of the each rib 111 includes a first chamfer 112. One end of transmission tenon 11 is coupled with the driving member of the printing apparatus, such as a gear 113. The transmission sleeve 12 has a tubular shape. The transmission sleeve 12 is internally provided with a plurality of radial grooves 121 that extend longitudinally parallel to an axis of the transmission sleeve 12. The grooves are evenly distributed and have a shape corresponding to that of the rib 111 of the transmission tenon 11. An outer edge of the each groove 121 is provided with a second chamfer 122 that facilitates the insertion and engagement of the rib 111 in the groove 121, and is adapted to couple with the first chamfer 112 of the rib 111 to reduce contact interference during rotation movement.

When the toner cartridge is assembled with the printing apparatus, the ribs 111 of the transmission tenon 11 engage with the grooves 121 of the transmission sleeve 12. The first chamfers 112 of the transmission tenon 11 and the second chamfers 122 of the transmission sleeve 12 make it easier to engage the transmission tenon 11 with the transmission sleeve 12. After the assembly, the gear 113 is driven by the printing apparatus; the transmission tenon 11 is driven to rotate by the gear 113; the transmission sleeve 12 is engaged with and driven to rotate by the transmission tenon 11; then, the driving axle in the cartridge body 20 is driven by the transmission sleeve 12.

The number of the grooves 121 is equal to a multiple of the number of the ribs 111. The number of grooves 121 according to the present embodiment is twice the number of the ribs 111. The multiple may also be three or another integer number larger than three. Because of the multiplying relationship between the numbers of the grooves 121 and the ribs 111, the number of locations where the transmission tenon 11 can engage with the transmission sleeve 12 is increased. Moreover, the ribs 111 and grooves 121 are aligned co-axial and evenly distributed. In the present embodiment, eight grooves 121 are evenly distributed along a full circle of 360 degrees. Therefore, each of the grooves 121 is spaced apart from the adjacent grooves 121 at an angle of 45 degrees. In other words, the maximum angle, which the rib 111 needs to rotate to reach a next engagement position, is 45 degrees. As a result, less wears occurs on the surfaces during the engagement of the transmission tenon 11 and the transmission sleeve 12, the lifespan of the product can be increased, and the time to the engagement position is reduced.

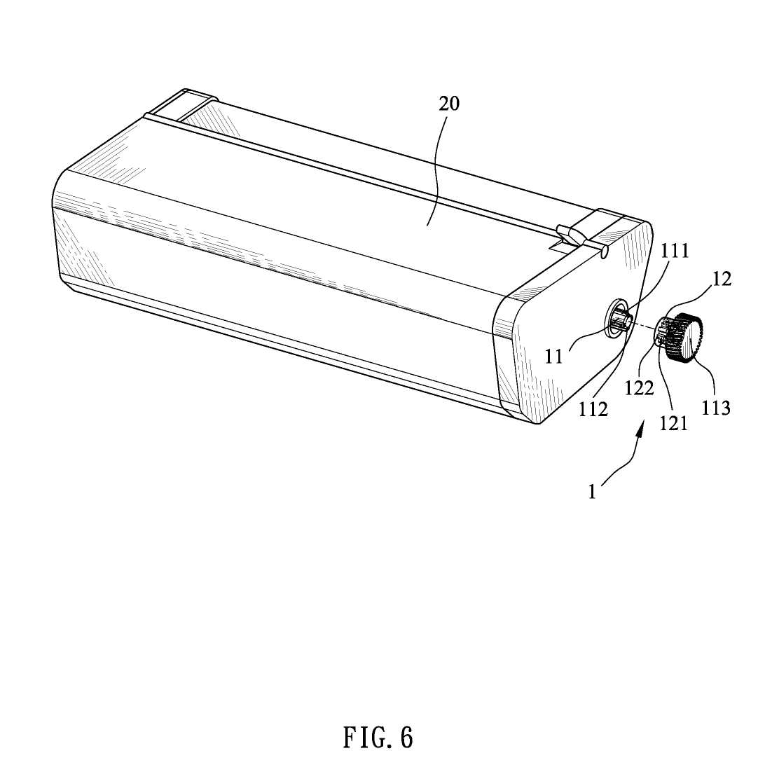

FIG. 6 shows a transmission mechanism 1 for a toner cartridge according to a second embodiment of the present invention. Similar to the first embodiment, the transmission mechanism 1 according to the second embodiment includes a transmission tenon 11 and a transmission sleeve 12. The structures and functions of the transmission mechanism 1 according to the second embodiment are similar to that of the first embodiment. The differences between the first embodiment and the second embodiment are that the transmission tenon 11 according to the second embodiment is coupled to a driving axle (not shown in figures) in a cartridge body 20 and the transmission sleeve 12 according to the second embodiment is coupled with a driving member of the printing apparatus, such as a gear 113.

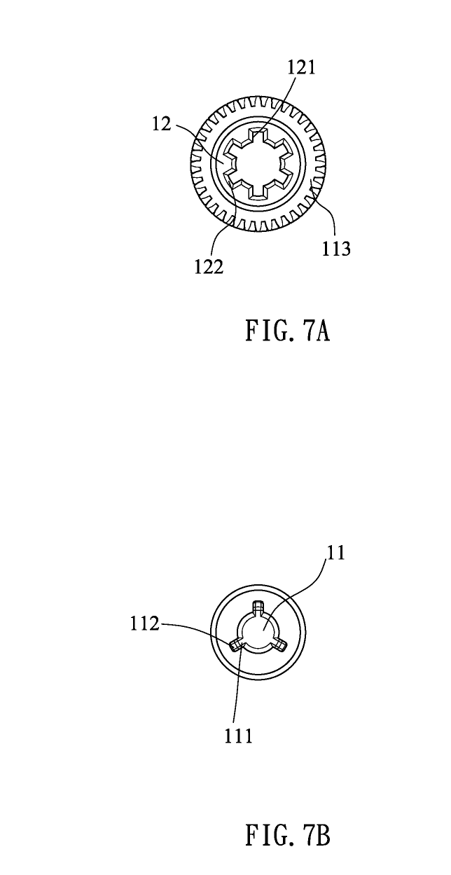

Referring to FIGS. 7A and 7B, a transmission mechanism for a toner cartridge according to a third embodiment of the present invention includes a transmission tenon 11 and a transmission sleeve 12. The structures and functions of the transmission mechanism according to the third embodiment are similar to that of the second embodiment. The differences between the second embodiment and the third embodiment are that the ribs 111 and grooves 121 are arranged at a ratio of 3 to 6. Further, the ribs 111 and grooves 121 may also be arranged at a ratio of 3/6, 3/9, 3/12, 4/12, 4/16, 5/10, 5/15, etc. The present invention has at least the following advantages:

1. As the transmission mechanism 1 for the toner cartridge provides multiple inserting engagement locations, the toner cartridge can be quickly assembled in the printing apparatus and put to work.

2. Because there are more locations that allow the ribs 111 of the transmission tenon 11 to be inserted into the grooves 121 of the transmission sleeve 12, friction wears are reduced at the contact locations between the ribs 111 and the grooves 121, thereby reducing malfunction occurrences.

3. The second chamfers 122 facilitate the insertion of the ribs 111 into the grooves 121. In addition, the coupling of the first chamfer 112 and the second chamfer 122 can reduce contact interferences, thereby reducing malfunction occurrences.

The foregoing description is intended to only provide illustrative ways of implementing the present invention, and should not be construed as limitations to the scope of the present invention. While the foregoing is directed to embodiments of the present invention, other and further embodiments of the invention may thus be devised without departing from the basic scope thereof, and the scope thereof is determined by the claims that follow.

What is claimed is:

1. A transmission mechanism for a toner cartridge for use in a printing apparatus, comprising:
a transmission tenon including a plurality of ribs, a front end of the each rib having a first chamfer; and
a transmission sleeve including a plurality of grooves, wherein a number of the grooves is a multiple of a number of the ribs, the grooves engaging with the rib of the transmission tenon, each of the grooves having a second chamfer;
wherein the transmission tenon and the transmission sleeve are respectively provided on either the toner cartridge or a driving member of the printing apparatus, whereby the printing apparatus is capable of driving the toner cartridge in movement after the transmission tenon engaging with the transmission sleeve.

2. The transmission mechanism according to claim 1, wherein the number of the grooves is twice the number of the ribs.

3. The transmission mechanism according to claim 1, wherein the ribs are evenly distributed and parallel to an axis of the transmission tenon.
